(19) United States
(12) Patent Application Publication
(10) Pub. No.: US 2014/0170258 A1
(43) Pub. Date: Jun. 19, 2014

(54) INJECTION MOLD WITH GATE INSERT DEFINING INCLINED GATE

(71) Applicant: HON HAI PRECISION INDUSTRY CO., LTD., New Taipei (TW)

(72) Inventor: Min-Tsang TSENG, New Taipei (TW)

(21) Appl. No.: 13/928,778

(22) Filed: Jun. 27, 2013

(30) Foreign Application Priority Data
Dec. 17, 2012 (TW) 101147757

(51) Int. Cl. B29C 45/27

(52) U.S. Cl. CPC B29C 45/2711
USPC 425/542

(57) ABSTRACT

An injection mold includes a mold plate and a gate insert detachably connected to the mold plate. The molding plate defines a runner for the inflow of melted injection material and a cavity for shaping the melted injection material into a product therein. The gate insert is positioned between the runner and the cavity and the upper portion of a downwardly-inclined gate in the gate insert has a sharp cutting edge, to present a clean ejection cut between the injection material in the runner and the finished product when ejected.

### BACKGROUND

1. Technical Field

The present disclosure relates to molds and, particularly, to an injection mold.

2. Description of Related Art

Injection molds are configured for molding melted injection material into predetermined shapes. An injection mold generally includes a mold plate. The mold plate defines at least one molding cavity and a runner communicated with the molding cavity, and the runner forms a gate at an end adjacent to the cavity. The injection mold usually works under high temperature and high pressure conditions and, thus, the gate may deformed, for example enlarged, degrading molding quality. In addition, it is difficult to repair the injection mold with a deformed gate and, therefore, the whole mold plate must be discarded if the gate of the injection mold is not qualified anymore, increasing cost.

What is needed therefore is an injection mold addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an exploded view of one embodiment of an injection mold, the injection mold including a gate insert.

FIG. 2 is an enlarged, isometric view of the gate insert of FIG. 1.

FIG. 3 is a cross-sectional view of the gate insert of FIG. 1, taken along line

FIG. 4 is an assembly view of the injection mold of FIG. 1.

### DETAILED DESCRIPTION

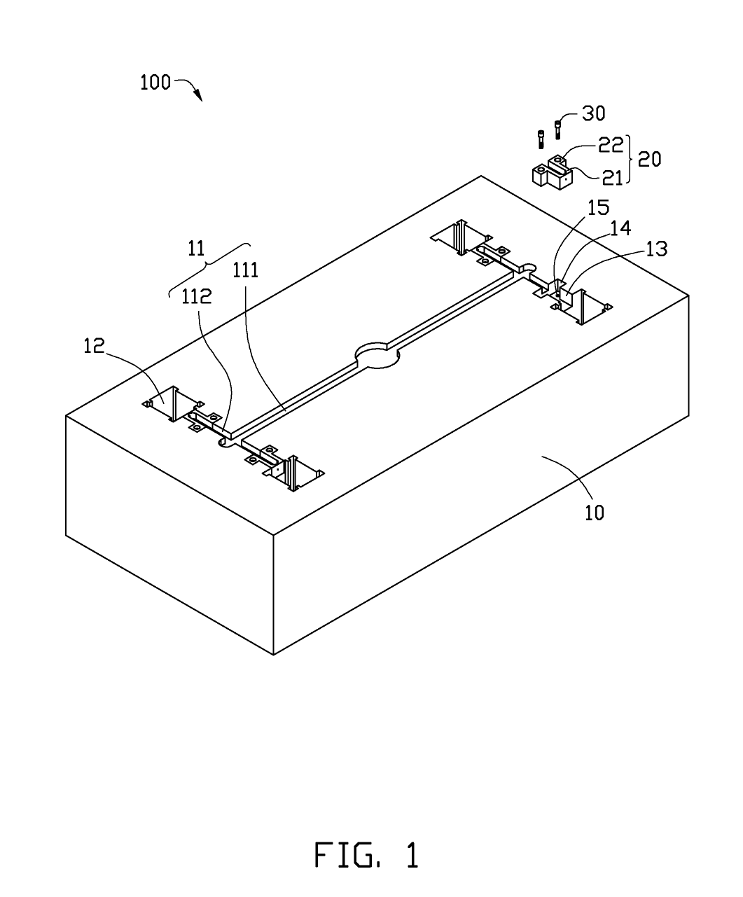

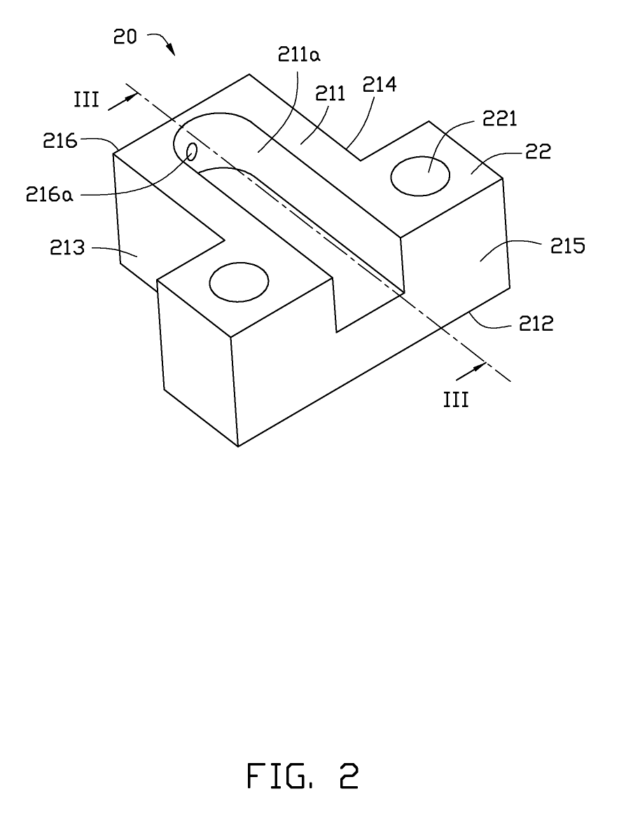

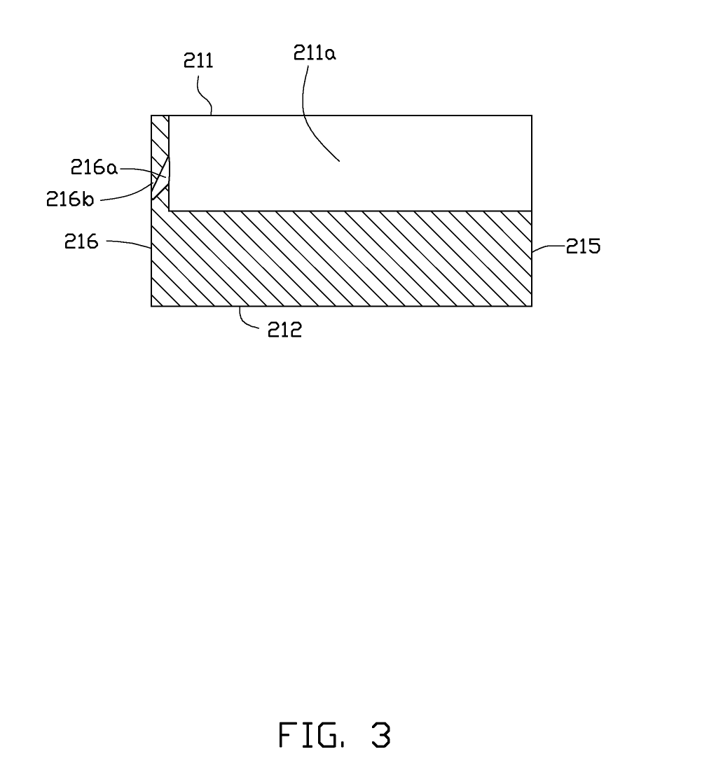

FIGS. 1-3 show one embodiment of an injection mold 100. The injection mold 100 includes a mold plate 10 and a number of gate inserts 20 positioned in the mold plate 10.

The mold plate 10 defines a runner portion 11 and a number of cavities 12 communicated with the runner portion 11. The runner portion 11 guides melted injection material (not shown) into the cavities 12. The runner portion 11 includes a main runner 111 and a number of secondary runners 112 communicating with the main runner 111. Each secondary runner 112 corresponds to a cavity 12 and allows communication a cavity 12 and a main runner 111. The mold plate 10 can be male or female. In this embodiment, the mold plate 10 is a mold plate of a female mold, and the mold plate 10 can mold products in cooperation with a mold plate of mating male mold. The cavities 12 are configured for molding products therein. The number of the cavities 12 can be changed according to different demands The number of the gate inserts 20 is determined by the number of the cavities 12. In this embodiment, the number of the cavities 12 is four.

The mold plate 10 further defines a number of receiving grooves 13 corresponding to the gate inserts 20. Each receiving groove 13 receives a gate insert 20 therein. Two opposite side surfaces in the receiving groove 13 each define an engaging groove 14 therein. A bottom surface of each engaging groove 14 defines a connecting hole 15. In this embodiment, the connecting holes 15 are threaded holes. Alternatively, only one engaging groove 14 or more than two engaging grooves 14 can be defined in the mold plate 10.

The gate inserts 20 are fixedly received in the receiving grooves 13. Each gate insert 20 includes a main portion 21 and two engaging blocks 22 protruding from two opposite sides of the main portion 21. The main portion 21 is substantially rectangular. The main portion 21 includes a top surface 211, a bottom surface 212 opposite to the top surface 211, a first side surface 213, a second side surface 214 opposite to the first side surface 213, a first end surface 215, and a second end surface 216 opposite to the first end surface 215. The main portion 21 defines an extending runner 211a in the top surface. An end of the extending runner 211a passes through the first end surface 215, and the other end of the extending runner 211a extends to the second end surface 216 and is a predetermined distance from the second end surface 216. The main portion 21 defines a gate 216a in the second end surface 216. The gate 216a extends from the second end surface 216 to the extending runner 211a and communicates with the extending runner 211a. The gate 216a serves as a passage for allowing the melted injection material to enter into the cavity 12 from the runner portion 11. In this embodiment, the gate 216a extends in a direction inclined to an extending direction of the extending runner 211a, and an opening of the gate 216a at the second end surface 216 is closer to the bottom surface 212, therefore, a sharp edge 216b is formed on the gate insert 20. In detail, the sharp edge 216b hangs over the bottom surface 212. The engaging blocks 22 are formed on the first side surface 213 and the second side surface 214. Each engaging block 22 defines a through hole 221 corresponding to a connecting hole 15. In this embodiment, each gate insert 20 is fixed in a receiving groove 13 by two bolts 30 through the connecting holes 15 and the through holes 221.

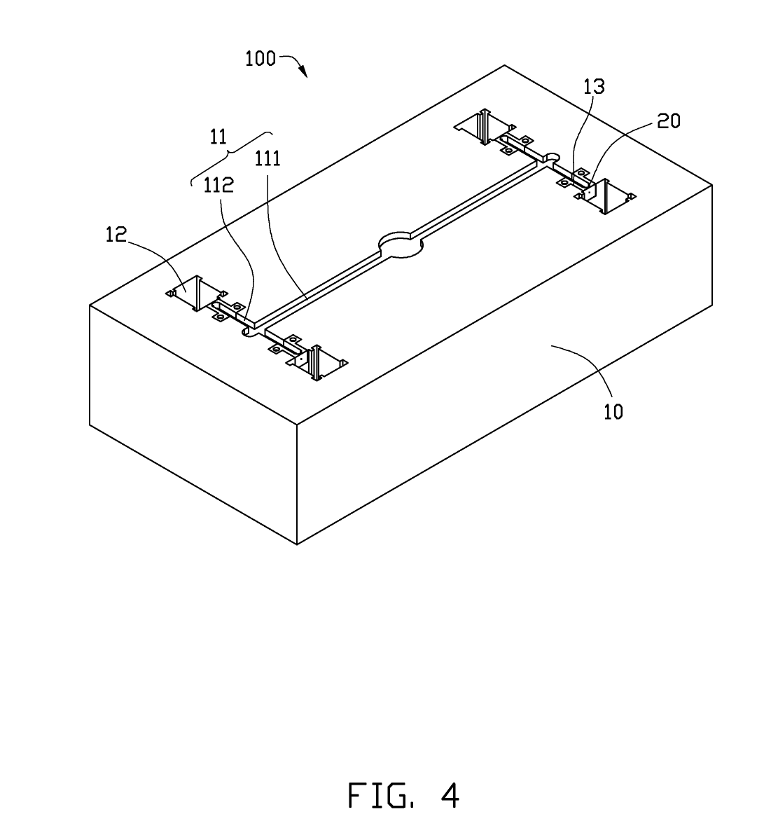

Referring to FIG. 4, in assembly, each of the gate inserts 20 is received in a respective one of the receiving grooves 13, and each of the engaging blocks 22 is engaged into a respective one of the engaging grooves 14. Each extending runner 211a is aligned with a secondary runner 112. A bolt 30 is inserted into a through hole 221 and is screwed into a connecting hole 15, thus fixing the gate insert 20 into the receiving groove 13.

In use, the mold plate 10 can mold products in cooperation with a mating mold plate (not shown) of the injection mold 100. Melted injection material is injected into the injection mold 100 by an injection machine (not shown). The melted injection material flows along the main runner 111, the secondary runners 112, the extending runner 211a, and finally enters into the cavities 12. Then, products with predetermined shape(s) can be molded. The molded products can be ejected out of the cavities 12 by an ejection mechanism (not shown). During the ejecting of the molded products, the sharp edge 216b of each gate insert 20 cuts a molded product cleanly from the material in the runner portion 11 and the gate insert 20, therefore, a cutting process of the molded product after the ejection process is eliminated.

If the gate 216a of a specific gate insert is enlarged beyond an allowable limit, only the specific gate insert 20 needs to be replaced by a new one and, therefore, the mold plate 10 can be repaired.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An injection mold, comprising:
a mold plate, the molding plate defining a runner portion for guiding melted injection material and a cavity for molding the guiding melted injection material into a product therein; and
a gate insert detachably connected between the runner portion and the cavity, the gate insert defining a gate therein, and the gate communicating the runner portion with the cavity.

2. The injection mold of claim 1, wherein the mold plate defines a receiving groove receiving the gate insert therein.

3. The injection mold of claim 2, wherein the gate insert comprises a main portion, the main portion comprises a top surface, a bottom surface opposite to the top surface, a first end surface, and a second end surface opposite to the first end surface, the gate passing through the second end surface.

4. The injection mold of claim 3, wherein the main portion defines a extending runner in the top surface, one end of the extending runner passes through the first end surface and another end of the extending runner is separated from the second end surface, and the gate is communicated with the cavity through the extending runner.

5. The injection mold of claim 4, wherein the gate extends in a direction inclined to an extending direction of the extending runner, and an opening of the gate at the second end surface is closer to the bottom surface than another opening of the gate at the extending runner.

6. The injection mold of claim 3, wherein the main portion comprises two opposite side surfaces and two engaging blocks respectively protruding from the side surfaces, two opposite side surfaces of the receiving groove each define an engaging groove, each of the engaging blocks is engaged into a respective engaging groove.

7. The injection mold of claim 6, wherein a bottom surface of each engaging groove defines a connecting hole, and each engaging block defines a through hole spatially corresponding to the connecting hole.

8. The injection mold of claim 7, wherein the connecting hole is a threaded hole, the injection mold comprises two bolts, and each bolt inserts into a corresponding through hole and is screwed in a corresponding connecting hole.
